(19) United States
(12) Patent Application Publication
(10) Pub. No.: US 2013/0333404 A1
(43) Pub. Date: Dec. 19, 2013

(54) SAFE AND COMPACT MACHINE FOR RAPIDLY PRODUCING FROZEN CONFECTIONS

(71) Applicants: Darryl H. Yong, Los Angeles, CA (US); Nancy K. Lape, Upland, CA (US); Bryan Chow, Livermore, CA (US); Rachid Grimes, San Pablo, CA (US); Samuel Joseph Ettinger, South Pasadena, CA (US); Wei Wei, Arcadia, CA (US); Julie Anne Kraus, Highland Park, IL (US); Jean-Vincent Hong, Torcy (FR); Joyce Chia-Hsin Lin, Taichung (TW)

(72) Inventors: Darryl H. Yong, Los Angeles, CA (US); Nancy K. Lape, Upland, CA (US); Bryan Chow, Livermore, CA (US); Rachid Grimes, San Pablo, CA (US); Samuel Joseph Ettinger, South Pasadena, CA (US); Wei Wei, Arcadia, CA (US); Julie Anne Kraus, Highland Park, IL (US); Jean-Vincent Hong, Torcy (FR); Joyce Chia-Hsin Lin, Taichung (TW)

(21) Appl. No.: 13/527,243

(22) Filed: Jun. 19, 2012

(51) Int. Cl. A23G 9/04; F25B 49/00

(52) U.S. Cl. 62/129

(57) ABSTRACT

The present invention safely freezes a confection very quickly, preferably in less than two minutes. The device includes an insulated refrigerant tank; one or more elevators; a mold; a mold holder mounted on the elevator; a refrigerant level monitoring subsystem capable of refilling the refrigerant tank; and, a user interface subsystem. The mold is preferably tapered with interior freezing surfaces such as tubes of refrigerant, which decrease the confection's freezing time.

### FIELD OF THE INVENTION

The present invention relates to devices for and processes of rapid manufacturing frozen confections such as popsicles, ices, ice cream, and frozen yogurt, which are typically presented to consumers on a stick or in a container. The invention can be configured for various production volumes.

### BACKGROUND OF THE INVENTION

Frozen confections have long been popular. U.S. Pat. No. 1,505,592 to Epperson describes the manufacture of popsicles. For decades, those with refrigerators have been freezing fruit juice and other confections in ice cube trays and other molds, while improvements to commercial equipment and consumer products have continued to develop. Today, the Zoku Quick Pop® maker claims to freeze popsicles in seven minutes. See www.zokuhome.com. Homemade ice cream was a favorite long before Breyers® appeared around the turn of the 20^{th} century, and since the 1950s Tastee-Freez® and others have sold soft-serve ice cream and similar confections. As size and cost have diminished, other devices for making ice cream have also become more successful and widespread. Because of the perceived health benefits of yogurt, the commercial presence of frozen yogurt has grown substantially, appearing in franchises like TCBY®, Menchie's®, and Pinkberry®, as well as in thousands of individual food and confection businesses. Such confections are usually prepared well in advance of consumption. For example, frozen yogurt is usually delivered to stores at temperatures well below freezing and in a solid state. This process facilitates packing, shipping, and storage. To create the soft texture of the final consumer product, the solid yogurt thaws at near freezing temperatures for a day or two and is then placed into a dispensing machine.

The development of frozen foods, from orange juice and vegetables to TV dinners and contemporary diet-based meals, has paralleled the development of frozen confections. Cryogenic temperatures are commonly used to accomplish the rapid freezing of food. U.S. Pat. No. 3,238,376 to Macintosh discloses a conveyer that passes through a thermally insulated tunnel in which food is sprayed with liquid nitrogen. A similar device appears in U.S. Pat. No. 4,157,650 to Guibert, in which vertical stacks of cooked meals on trays are exposed to a cryogenic liquid. Because of its chemical stability and cost, liquid nitrogen (“LN2”) has frequently been the preferred refrigerant of cryogenic devices and methods. U.S. Pat. No. 3,431,745 to Harper et al discloses flash freezing accomplished by spraying LN2 in a vacuum-insulated chamber. Because of the prevalence of LN2 in the freezing process, numerous devices have been created to monitor or control the amount of LN2 in the process. Such devices include U.S. Pat. No. 4,187,723 to Golden et al, U.S. Pat. No. 4,404,809 to Johnson et al, U.S. Pat. No. 3,863,669 to Ishida et al, and U.S. Pat. No. 4,691,793 to Kumakura et al. Similarly, molds, containers, and holders for frozen confections have also been developed. Examples can be seen in U.S. Pat. No. 2,682,234 to Baldanza et al, U.S. Pat. No. 4,352,830 to Billet et al, and U.S. Pat. No. 5,403,051 to Watkins.

There is a continuing need for a product that can create frozen confections quickly, efficiently, and with lower costs. Current products are often complicated, difficult to store, and difficult to use. Furthermore, there is a need for a freezing device that can advantageously use fresh and organic ingredients without the delays and complexity inherent in typical commercial processes. In addition, the use of cryogenic temperatures poses safety problems that require care and attention, so that the extreme temperatures do not harm operators of the freezing device.

### SUMMARY OF THE INVENTION

The invention has a number of advantages. It can rapidly freeze confections, preferably in less than two minutes. The process is easily repeatable. The freezing device can be made compact and require little operator expertise. It should protect the operator from direct exposure to the refrigerant, which can severely damage a user's skin and eyes. While it is envisioned that the invention will be most beneficial to small businesses that create popsicles and similar products on the business premises, it could also be modified for use in other settings.

The present invention is a useful process and machine for freezing confections typically on the order of 100 to 300 milliliters in volume. Consequently, consumers can select ingredients for a frozen confection and receive an edible product in a few minutes. Cryogenic temperatures ensure very rapid freezing. In addition to satisfying the commercial or personal demand for a speedy process, the rapid freezing prevents settling of the flavoring and other non-soluble ingredients in the confection. Thus, a more even mixture and distribution of the ingredients results in both a better taste and a more pleasing texture.

The invention consists of a bath of refrigerant and an elevator mechanism that submerges and lifts confections into and out of the bath. Before submersion, a mold containing the confection is secured in the elevator. To produce frozen confections quickly, LN2 is used as the preferred refrigerant. The invention includes the following: a tank with insulation subsystem; an elevator subsystem; a mold; a refrigerant level monitoring subsystem; a refrigerant refilling subsystem; a nitrogen gas control subsystem; and, a user interface subsystem. The mold is preferably tapered with interior and exterior freezing surfaces that decrease the confection's freezing time.

### BRIEF DESCRIPTION OF THE DRAWINGS

FIG. 1 is a perspective view of the invention, including the tank and the elevator system.

FIG. 2 is a schematic perspective of the freezing tank, an electrical LN2 monitor, and an LN2 supply.

FIG. 3 is a perspective view of the top of the device and the elevator system.

FIG. 4 is a perspective view of one of the preferred molds for use with the invention.

FIG. 5 is a perspective view of another mold.

FIG. 6 is a perspective of a refrigerant cooling tube that fits inside the mold.

FIG. 7 is a perspective of a convection holder that can be used to hold the confection that comes out of the mold in FIG. 5.

FIG. 8 is a perspective view of yet another mold.

FIG. 9 is a perspective of the bottom cover of the mold in FIG. 8.

### DETAILED DESCRIPTION OF THE INVENTION

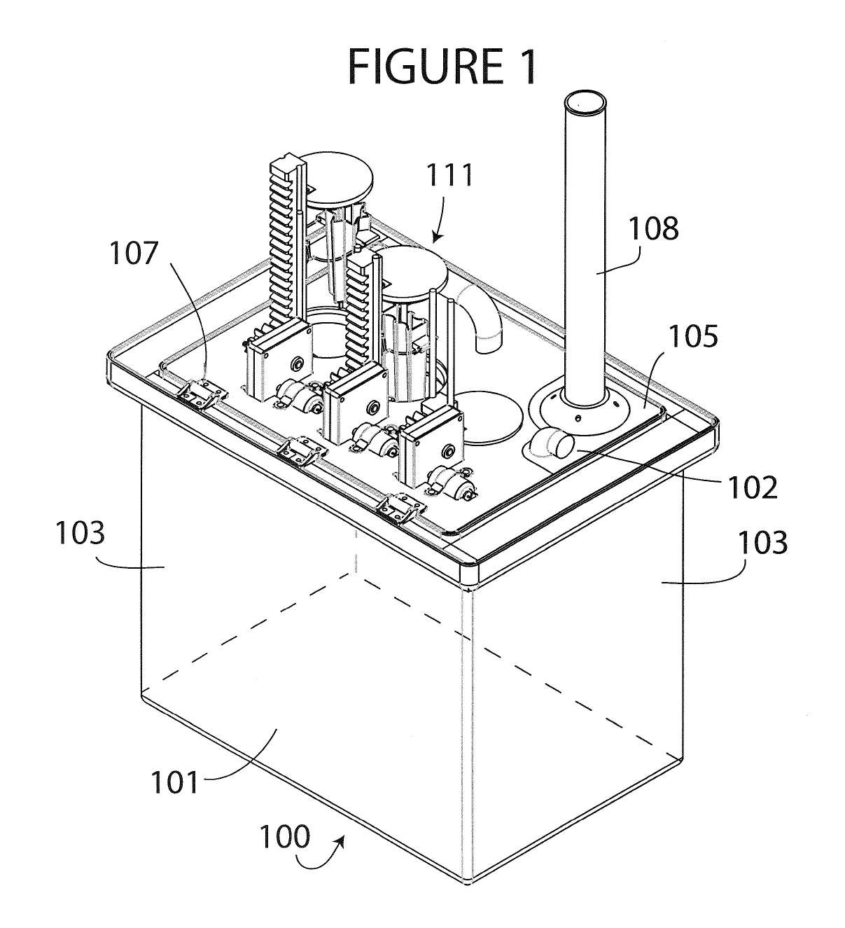

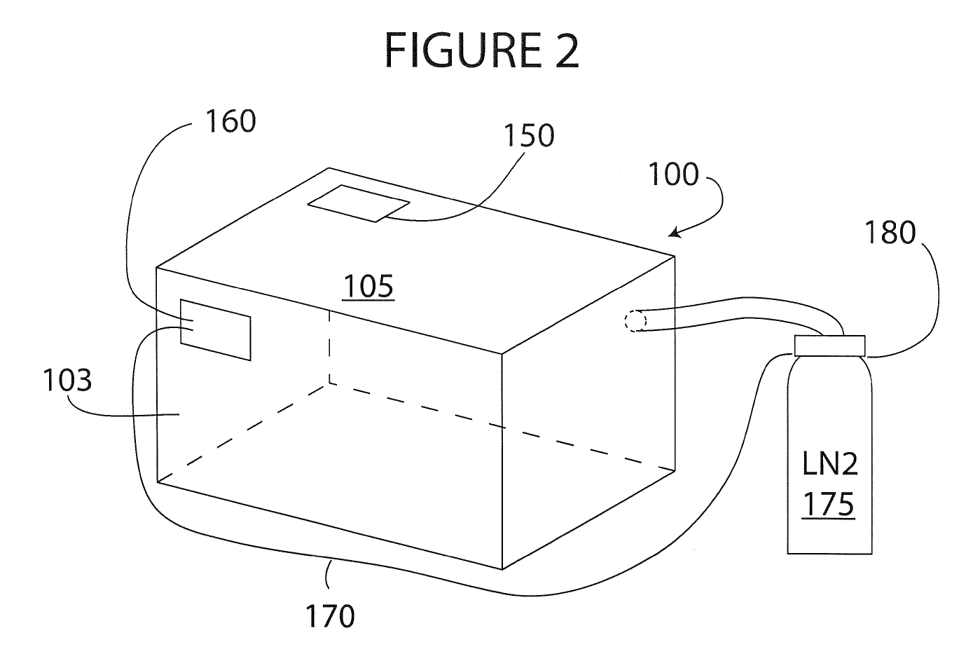

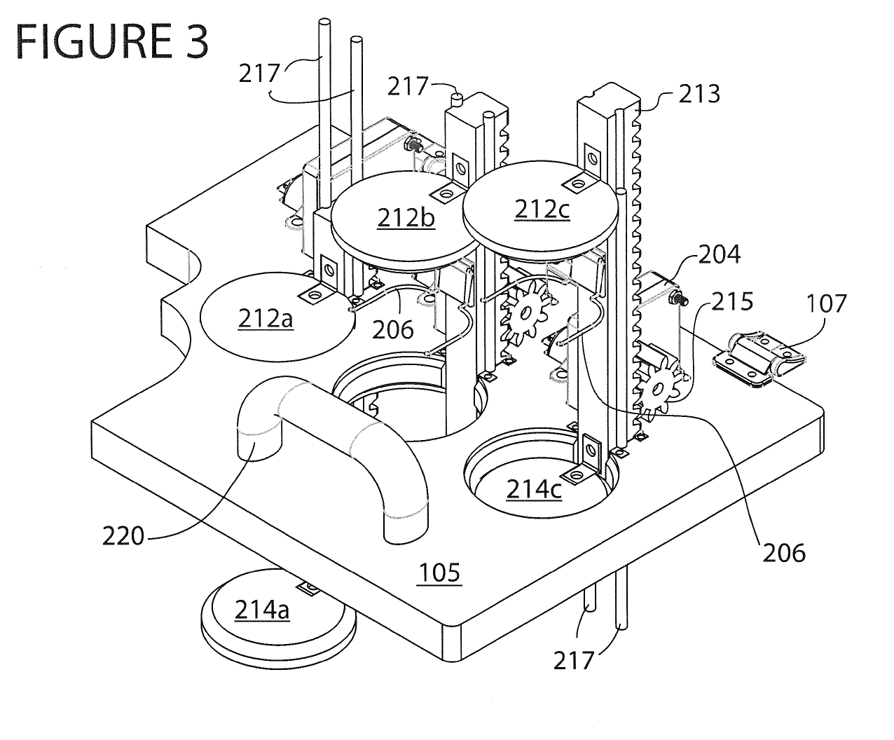

FIG. 1 is a general depiction of the invention 10. The embodiment depicted in the figures and described below is designed for simultaneously freezing three confections, although the invention can be constructed for one confection or as many confections as can be practicably managed. A prototype of the device capable of freezing three confections is approximately 24 inches wide, 14 inches deep, and 12 inches high from the base 101 to the cover 105. To accommodate three molds on three elevators, insulated freezing tank 100 typically holds about 15 liters of LN2, which represents approximately 20 percent of a commercially available 70-liter tank 175 of LN2, as depicted in FIG. 2. Depending on the number and size of molds and the size of the tank used, the invention operator may purchase larger or smaller quantities of LN2. The freezing tank 100 is comprised of insulated walls 103 and an insulated base 101 that contain the refrigerant, preferably LN2. Many of the moving parts of the invention reside on cover 105 that sits top of tank 100. Hinges 107 connect the insulated cover 105 and walls 103, permitting access to freezing tank 100 so the device can be maintained and cleaned. Handle 220 (FIG. 3) permits access to the inside of insulated freezing tank 100. For safety purposes, the cover 105, walls 103, and base 101 of insulated freezing tank 100 isolate the operator from the refrigerant.

The invention includes a refrigerant level monitoring subsystem 160 that determines the level of the refrigerant in freezing tank 100. In FIG. 2 monitoring subsystem 160 alerts the operator when the refrigerant level is low, and it also alerts the operator when the level is too high. Tank 100 should not be filled completely, because the refrigerant must have room to boil when molds filled with the confection are submerged to be frozen. As depicted in FIG. 1, one embodiment of the device determines the refrigerant level by using a mechanical float consisting of a plastic ball and attached rod (not shown), not unlike the ballcock of a toilet. The preferred embodiment of the monitoring subsystem 160 uses an electronic or electromechanical monitoring device. For example, FIG. 2 schematically depicts freezing tank 100, with an electrical monitor 160 mounted on the inside of one of the walls 103.

Preferably the LN2 refilling subsystem automatically refills the tank with as little intervention from the operator as possible. In one variation of the device, the LN2 monitoring subsystem alerts the operator to low levels of LN2, after which the operator must then fill the tank by attaching the source of LN2 to refilling port 102. As depicted in FIG. 1, the refilling port 102 is best located on cover 105, or else near the top of one of the walls 103. With such an external port it is unnecessary to lift cover 105, which could cause wasteful evaporation of the refrigerant, whether it is LN2 or another substance. In another variation of the device, as depicted in FIG. 2, an actuator 180 that can automatically allow the transfer of LN2 from pressurized container 175 into the tank 100 may be connected to and part of the monitoring subsystem 160. Also, the LN2 tank can be connected permanently to refilling port 102, so that the LN2 monitoring and refilling are all accomplished automatically, without the need for operator monitoring or intervention.

The invention should have a gas exhaust to allow any gas that is created by the boiling of the refrigerant to escape in a safe manner. The process may be aided by fans that move the gas to the open atmosphere. As depicted in FIG. 1, acrylic tube 108 permits gas, such as N₂, to exhaust into the surrounding air.

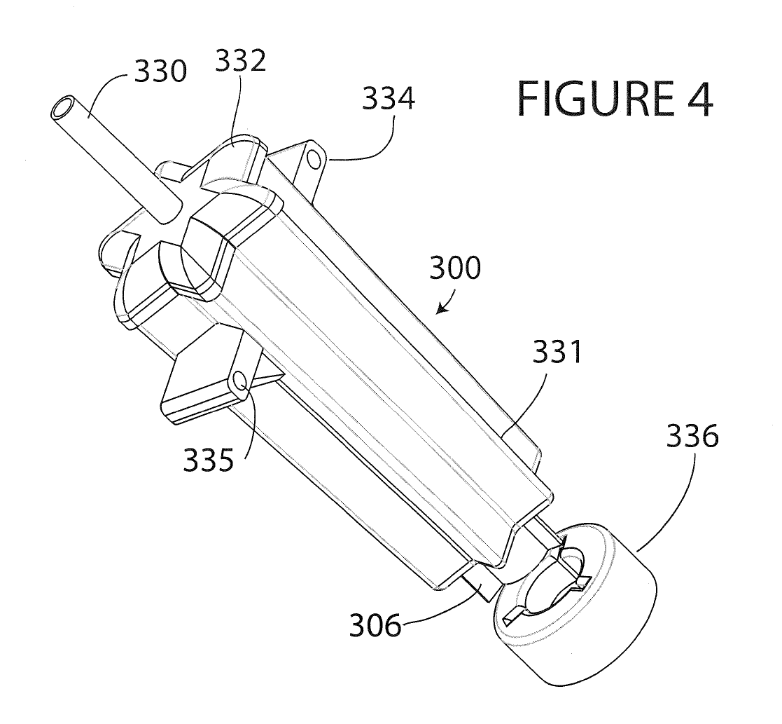

The invention includes an elevator subsystem 111 to move confections in and out of the refrigerant bath without the operator having to come into contact with the refrigerant. Each elevator includes a holder 206, which is preferably made of a flexible material that can withstand the low temperatures of the refrigerant in tank 100. Each holder 206 holds a mold which contains a liquid confection that is frozen in tank 100. A rack 213 and pinion 215 mechanism powered by a motor 204 accomplishes this function. The rack is supported by guide bars 217. The invention may have any number of elevator subsystems, depending on the size of the tank. FIGS. 1 and 3 depict a device with three elevators, each one capable of holding a separate confection mold. FIG. 3 depicts an elevator subsystem with three elevators at different heights. Each elevator has an upper cover 212a, b, c and a lower cover 214a, b, c, (214b not shown) which prevent unwanted evaporation of the refrigerant and which also create a barrier between the operator and any splashing refrigerant. Examples of such molds 300, 400, 500 appear in FIGS. 4, 5, 8 but for clarity are not shown in FIG. 3. For example, at the left of FIG. 3 upper cover 212a would seal an opening in cover 105 while the liquid confection is fully submerged and freezing in tank 100. Conversely, when a mold (not shown in FIG. 3) is waiting to be submerged it would be secured by holder 206 between upper cover 212c and lower cover 214c. Thus, lower cover 214c seals an opening in cover 105 so that no refrigerant can leak from tank 100. In the middle elevator of FIG. 3, upper cover 212b depicts the configuration of the elevator while a mold is being raised or lowered. If desired, each elevator could include a mold container, which would include sides (not shown) that extend between the edge of upper cover 212 and the edge of lower cover 214. With this structure, even a partially submerged mold, as suggested by upper cover 212b, would seal the opening in cover 105 through which the mold passes as the elevator is raised or lowered.

FIG. 2 is a schematic diagram that suggests the possible controls for the invention. An electric monitor 160 senses the refrigerant level in tank 100. If the refrigerant level is too low, monitor 160 sends a signal through wire 170 to actuator 180 associated with the tank of LN2 175. The actuator then opens tank 175 to allow the appropriate amount of refrigerant to flow into tank 100. The invention is not limited to such an arrangement, and may comprise any mechanical, electrical, or electromechanical combination. A prototype of the invention was constructed for testing and used a mechanical float to determine refrigerant level, and the refrigerant tank 175 was opened by hand to let in the necessary amount of refrigerant. Preferably a user interface subsystem which would include keypad 150 would allow the operator to control a variety of functions. One such critical function is the duration of the submersion of the confections in the refrigerant. A field-programmable gate array can be used to control the motor that changes each elevator system's position. The user interface subsystem could allow the operator to automate the submersion of individual confection molds in each elevator. For commercial embodiments of the invention, the retail operator, the individual user, or both could be provided with programmable options. For example, the user could select one of two or three flavors available for insertion into the mold. The user might also be given limited control over the amount of the confection placed in the mold. Even if submersion were automated, say in a retail establishment, a display could provide the user with the remaining submersion time. In one embodiment of the invention, as depicted in FIG. 2, the user interface system 150 can be connected to electric monitor 160 and actuator 180 so that the operator has complete control over the system. If desired, the invention can be constructed so that signals between various components can be sent wirelessly. In FIG. 2 a keypad 150, possibly with a display, for controlling the interface system is disposed on the top 105 of tank 100. The keypad, however, can be located almost anywhere, as long as it is capable of transmitting and receiving signals related to control of the invention. Alternatively, control over the invention could be provided by applications downloaded to computers, tablets, smartphones, and other electronic devices with similar capabilities. Those of skill in the art will understand the variety of monitoring and control subsystems available and can choose such systems based on the need for accuracy, durability, cost, and other commercial or aesthetic factors.

The present invention includes molds to form each frozen confection. Such molds 300, 400, 500 are depicted in FIGS. 4, 5 and 8. The molds allow the ingredients of each confection to be sequestered from the refrigerant, creating a safe and simple system for the insertion and removal of the ingredients from the device, and reducing the freezing time of the confection as much as possible. The mold will be made from a combination of plastic and metal—differences in thermal conductivity of constituent materials can be exploited to control the speed of freezing of the confection. In addition, the freezing time of the confection is proportional to the greatest distance of the liquid confection from the refrigerant. Therefore, to decrease the freezing time, one or more holes are introduced into the mold to accommodate tubes of refrigerant. For these holes to be effective, they must go all the way through the mold so as not to trap gaseous nitrogen, which is an insulator. Numerical simulations of freezing under the same conditions as those present in the invention indicate that the freezing of confections can be reduced by as much as 60 percent using such holes. The holes can later accommodate a stick on which the frozen confection is served.

One sample mold 300 is shown in FIG. 4. The mold has 12 sides 331, which provides substantial surface area to facilitate freezing. A mold preferably contains 100 to 300 ml of liquid to be frozen. Connected to the sides 331 are two wings with holes 334, 335 through which pass holders 206 to secure the mold on the elevator while the confection is frozen. A tube 330 down the center of the mold allows for the refrigerant to pass freely along the center of the mold. Freezing the confection near the mold center speeds the process of making the frozen confection. The cover 332 can be used for serving the confection to consumers. Removal device 336 may be secured to one of the lower covers, e.g., 214a, 214c, to allow for the frozen confection to be quickly removed. Alternatively, removal device 336 can serve as an additional cover to the tube to allow the frozen confection to be placed in a warm water bath for removal, if necessary. It can also be used to push the tube out, along with the frozen confection. It should be noted that mold 300 tapers from the narrow end near removal device 336 to the wider end at cover 332. Mold 300 should be tapered for easier removal of the frozen confection. Variations in the shape of mold 300 are possible, but preferably the mold should have a somewhat tapered shape resembling or analogous to a conical frustum. By way of example, in FIG. 4 a cross-section of mold 300 would appear as a polygon inscribed a cross-section of a conical frustum.

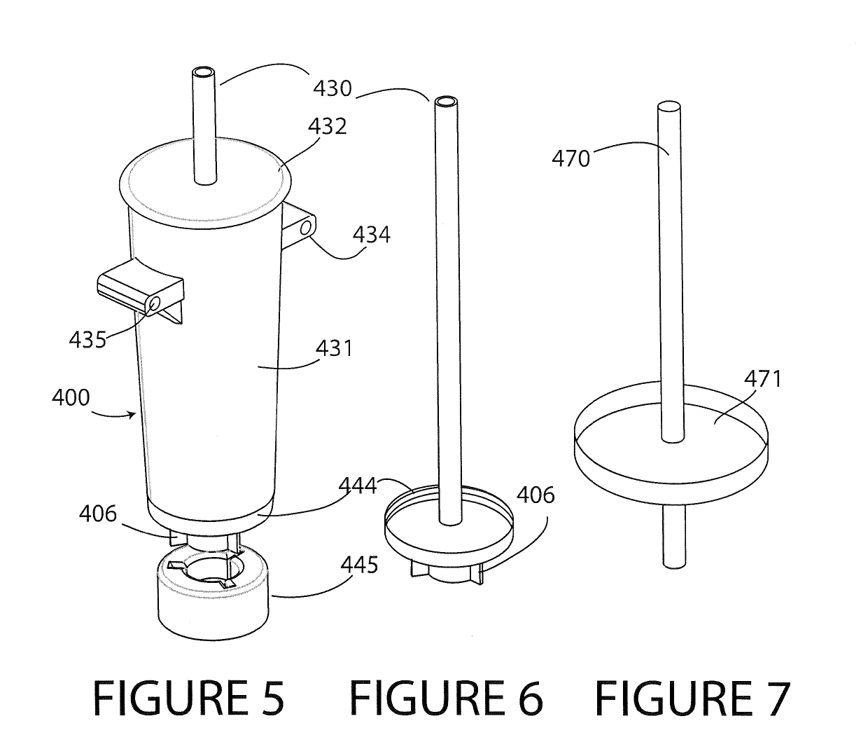

In the embodiment shown in FIG. 5, the mold side 431 is shaped liked a conical frustum and tapers from 1¾ inches at the upper end by cover 432 to 1¼ inches by lower cover 444. In FIG. 5 cover 444 could be unscrewed from sides 431 to facilitate easy removal of the confection from the mold. FIG. 6 shows how the tube 430 is integrated into the lower cover 444. The tube 430 allows LN2 to pass through the center of the confection so that the confection freezes faster. Because the freezing time of the confection is mainly limited by the thermal conductivity of the frozen confection, reducing the greatest distance from the LN2 to any interior point of the confection is the key to bringing the freezing time under two minutes. After freezing, removal of cover 444, cover 432, and tube 430 will leave a hole in the frozen confection. This hole can be filled with a convenient confection holder, such as that shown in FIG. 7. The confection holder consists of a wooden stick 470 that fits into the hole in the frozen confection left by tube 430, and has a skirt 471 to catch the liquid from the melting confection.

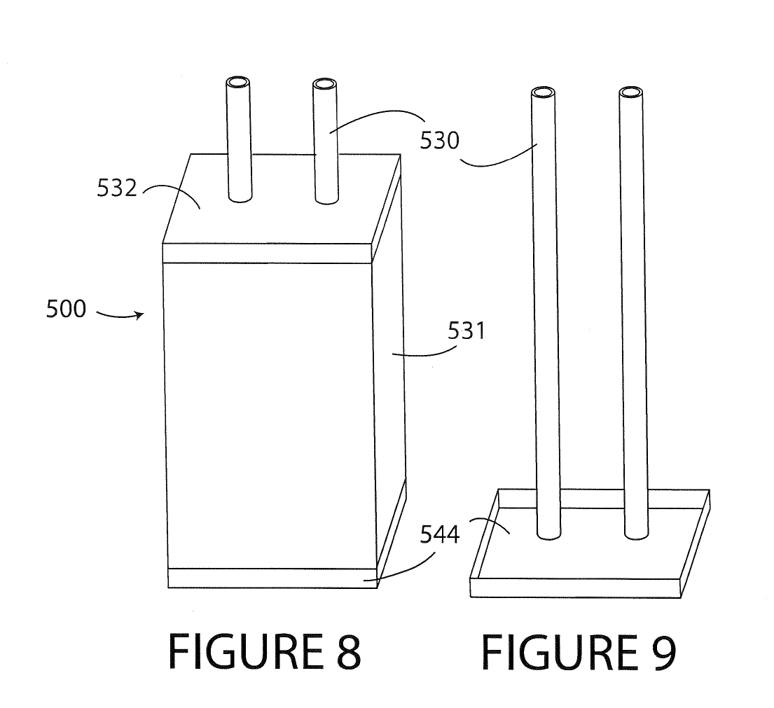

In the embodiment shown in FIG. 8, the mold sides 531 form a rectangular prism, not unlike the general shape of many standard store-bought frozen confections. A single mold would be about 2.5 inches wide, ¾ inches deep, and 4 inches tall. In FIG. 9, bottom cover 544 and top cover 532 could be removed from sides 531. As mentioned previously, the tubes 530 allow LN2 to pass through the confection so that it can freeze under two minutes. Depending on the shape of the desired mold, any number of tubes can be incorporated into the mold to increase the surface area of contact between the confection and the refrigerant and to decrease the greatest distance from the interior of the confection to the surface of contact with the refrigerant.

While the preceding written description of the invention enables a person of ordinary skill to make and use what is believed to be the best variations of a device for the rapid freezing of a frozen confection, it can be understood that there are other variations, combinations, and equivalents of the specific embodiments, methods, and examples provided herein. For example, the invention can be modular, allowing for one or more combinations of tanks, elevators, and molds. Similarly, the elevator is not limited to a rack and pinion structure, and could, if desired, be modified to hold more than one confection mold. The monitoring and control features are only limited by the state of the art of electronic control systems. But, as noted earlier, such systems can also be simplified so that monitoring and control of the invention is accomplished visually and manually. Rather than tubes, the molds could include manifolds or some other structure to hold refrigerant. Therefore, the invention should not be limited by the above described embodiments, methods, and examples, but by all embodiments and methods within the scope and spirit of the invention.

1. A device for making frozen confections, comprising:
an insulated refrigerant tank with a base, sides, and top defining an inside and outside of the refrigerant tank;
a source of refrigerant
a refrigerant filling port;
an elevator movable between the outside and the inside of the refrigerant tank, the elevator including a holder;
a confection mold releasably attachable to the holder, the mold having an interior and exterior; and,
a refrigerant level monitor.

2. The invention of claim 1, wherein the interior of the confection mold includes a refrigerant tube.

3. The invention of claim 2, further comprising at least one additional elevator and mold.

4. The invention of claim 2, wherein the elevator is adapted to seal the refrigerant tank.

5. The invention of claim 2, further comprising a refrigerant gas exhaust.

6. The invention of claim 2, further comprising a float for monitoring the refrigerant level.

7. The invention of claim 2, wherein the refrigerant level monitor is electronic and associated with a source of refrigerant.

8. The invention of claim 7, further comprising an electronically controlled actuator associated with the refrigerant source.

9. The invention of claim 2, wherein the mold comprises at least one removable end associated with the tube.

10. A system for making frozen confections, comprising:
an insulated refrigerant tank with a bottom, sides, and top defining an inside and outside of the refrigerant tank;
a source of refrigerant for the refrigerant tank;
at least one elevator movable between the outside and the inside of the refrigerant tank, the elevator comprising a top cover and a bottom cover passable through and sealable with the refrigerant tank;
a confection mold releasably attachable to the elevator between the top cover and the bottom cover, wherein the confection mold comprises an inside and an outside and includes a refrigerant tube inside the mold; and,
a system for monitoring and maintaining a specified amount of refrigerant in the refrigerant tank.

11. The invention of claim 10, further comprising a user interface for controlling the duration of confection mold submersion in the refrigerant tank.

12. The invention of claim 10, wherein the confection mold further includes at least one removable cover.

13. The invention of claim 10, wherein the removable cover is configured to be usable as a holder while the confection is eaten.

14. The invention of claim 13, wherein the removable cover is reusable.

15. The invention of claim 13, wherein the removable cover is designed to be disposable after a single use.

16. The invention of claim 10, wherein a plurality of refrigerant tubes are disposed inside the mold.

17. The invention of claim 11, wherein the confection mold is tapered.

18. The invention of claim 11, wherein the mold is generally shaped like a conical frustum.
